(19) United States
(12) Patent Application Publication
(10) Pub. No.: US 2007/0290959 A1
(43) Pub. Date: Dec. 20, 2007

(54) Instrument cluster for a vehicle

(76) Inventor: Bong-Kwan Kim, Cheongju-si (KR)

Correspondence Address: COLEMAN SUDOL SAPONE, P.C., 714 COLORADO AVENUE, BRIDGE PORT, CT, 06605-1601, US

(21) Appl. No.: 11/485,156

(22) Filed: Sep. 14, 2006

(30) Foreign Application Priority Data
Jun. 20, 2006 (KR) 2006-0055370

(51) Int. Cl. G09G 3/00

(52) U.S. Cl. 345/82

(57) ABSTRACT

An instrument cluster for a vehicle is disclosed. A display panel with markings and characters of various gauges, such as a speedometer, tachometer and hydraulic gauge, displays information on various conditions and operations of vehicle. An indicating pointer indicates the markings. An LED placed at the rear side of the display panel illuminates the display panel during nighttime operation. A gauge motor rotates the indicating pointer. A three-dimensional illumination panel is placed on the display panel and has markings or characters formed three-dimensionally by Nd-YAG laser.

### BACKGROUND OF THE INVENTION

1. Field of the Invention

The present invention relates to an instrument cluster for a vehicle, and more specifically to an instrument cluster for a vehicle in which a display panel is three-dimensionally provided with a three-dimensional illumination panel formed in three-dimensional shapes, so that the visual effect is enhanced to improve the visibility of the instrument panel for the driver, and the instrument panel can be classily presented with splendid appearance and illumination of diverse colors.

2. Description of the Related Art

In general, the instrument panel of a vehicle is provided with various gauges to inform the driver of various conditions of the vehicle and operational information. The instrument panel of a vehicle includes a speedometer for displaying the speed of the vehicle, a tachometer for displaying the revolution speed of the engine, and various gauges for displaying the engine temperature and hydraulic pressure level, for example.

FIG. 5 is a plan view of a conventional instrument panel for a vehicle of prior art, and FIG. 6 is a cross sectional view taken along line A-A′ of FIG. 5.

As shown in these drawings, an ordinary instrument panel for a vehicle is provided with a speedometer a for showing the speed of the vehicle, a tachometer b for showing the speed of engine, and various gauges such as a hydraulic gauge c for showing the hydraulic pressure level of engine.

The instrument panel is provided with a display panel 200 with characters, markings, etc. printed thereon to show in analog the values of various gauges such as the speedometer, tachometer and hydraulic gauge. On the display panel 200 is placed an indicating pointer 300 for indicating the markings. The indicating pointer 300, which is connected to a rotating output shaft of a gauge motor 400 installed on the back of the display panel 200, indicates the markings while rotating on the display panel.

And, on the front of the instrument panel is fitted a transparent cover 500 to protect the display panel 200 from external shock, and on the rear side of the instrument panel is assembled a body frame 700 to illuminate the display panel 200 by reflectively diffusing the light of LED 600. The body frame 700 provides a predetermined space between the components making up the instrument panel for mounting them. The Light Emitting Diode (LED) 600, which is the light source for background illumination, is supported and fixed by an LED supporter 610 in the space between the body frame 700 and the display panel 200.

And to the rear of the instrument panel is assembled a rear cover 900 to protect various parts and shield electromagnetic waves, and in front of the rear cover 900 is placed a printed circuit board 800 which processes various signals to operate various gauges, warning lights, LCD, etc. Fixed to the printed circuit board 800 by screws is a gauge motor 400 for rotating the indicating pointer 300. Another function of the rear cover 900 is to improve indoor temperature characteristics by facilitating thermal diffusion of heat emitting parts. For this purpose, aluminum sheet is used, so it is possible to make it lighter than the conventional plastic cover. At this time, it is also possible to configure the screws in such a way that they play a role of transmitting electrical signals from the printed circuit board 800 to the gauge motor 400.

The above-described conventional instrument panel for a vehicle has its visibility lowered because the characters and markings are marked simply on a flat display panel, so the driver cannot easily perceive the condition of vehicle during driving. Because of this, it has a problem in that requirements for safe operation and comfortable driving through accurate understanding of vehicle conditions are not sufficiently met.

Another problem is that even if the display panel is illuminated by LED during nighttime driving, the characters and markings are marked only on the surface of the display panel, so the visibility is low.

### SUMMARY OF THE INVENTION

Therefore, in order to solve such problems, it is an object of the present invention to provide an instrument cluster for a vehicle, which enables the driver to drive in a safe and pleasant environment by providing the instrument panel of the vehicle with a three-dimensionally formed three-dimensional illumination panel so as to improve the visibility of the instrument panel for the driver and enable the driver to understand the vehicle conditions more easily.

Another object of the present invention is to provide an instrument cluster for a vehicle which presents splendid and classy appearance during nighttime illumination of the instrument panel by illuminating the three-dimensionally formed three-dimensional illumination panel with LED of diverse colors.

In accordance with the present invention, there is provided an instrument cluster for a vehicle, comprising: a display panel with markings and characters of various gauges, such as a speedometer, tachometer and hydraulic gauge, displaying information on various conditions and operations of vehicle; an indicating pointer for indicating the markings; an LED placed at the rear side of the display panel for illuminating the display panel during nighttime operation; a gauge motor for rotating the indicating pointer; and a three-dimensional illumination panel which is placed on the display panel and has markings or characters formed three-dimensionally by Nd-YAG laser.

Preferably, the instrument cluster for a vehicle further comprises a plurality of colored LEDs placed at rear of the display panel so as to illuminate the three-dimensional illumination panel in diverse colors.

Preferably, the instrument cluster for a vehicle further comprises diverse patterns and pictures formed in three-dimensional shapes inside of the three-dimensional illumination panel by Nd-YAG laser.

Preferably, the three-dimensional panel is injection-molded with acryl resin, which is a transparent material.

Preferably, the three-dimensional illumination panel is made of crystal material.

### BRIEF DESCRIPTION OF THE DRAWINGS

Other objects and aspects of the present invention will become apparent from the following description of embodiments with reference to the accompanying drawings in which:

FIG. 1 is a perspective view showing a three-dimensional illumination panel according to the present invention;

FIG. 2 is a perspective view showing a main part of an instrumental panel installed with the three-dimensional illumination panel of FIG. 1 according to a preferred embodiment of the present invention;

FIG. 3 is a schematic view showing a three-dimensional carver of a three-dimensional illumination panel according to the present invention;

FIG. 4 is a perspective view showing the illumination structure of a colored LED installed on an instrument cluster for a vehicle according to the preferred embodiment of the present invention;

FIG. 5 is a plan view of an instrument cluster for a vehicle of prior art;

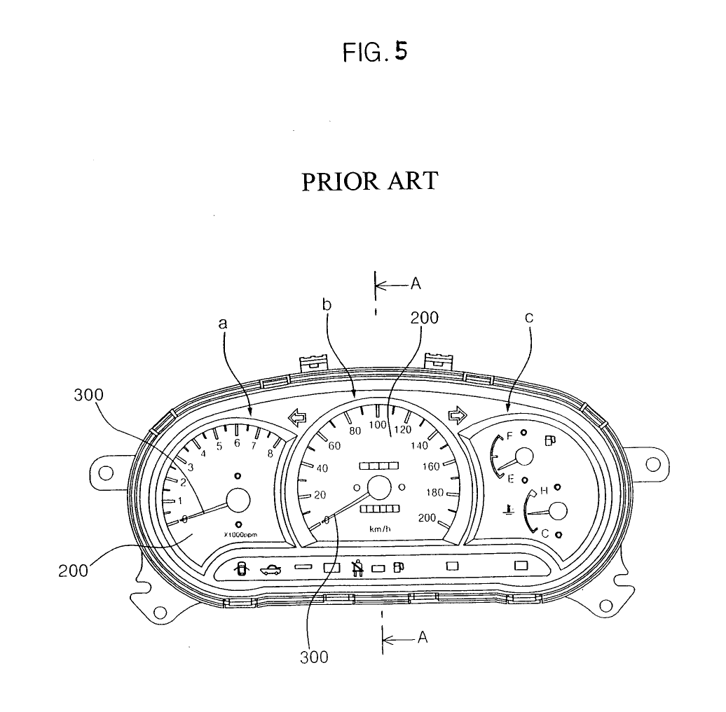

FIG. 6 is a cross sectional view taken along line A-A′ of FIG. 5.

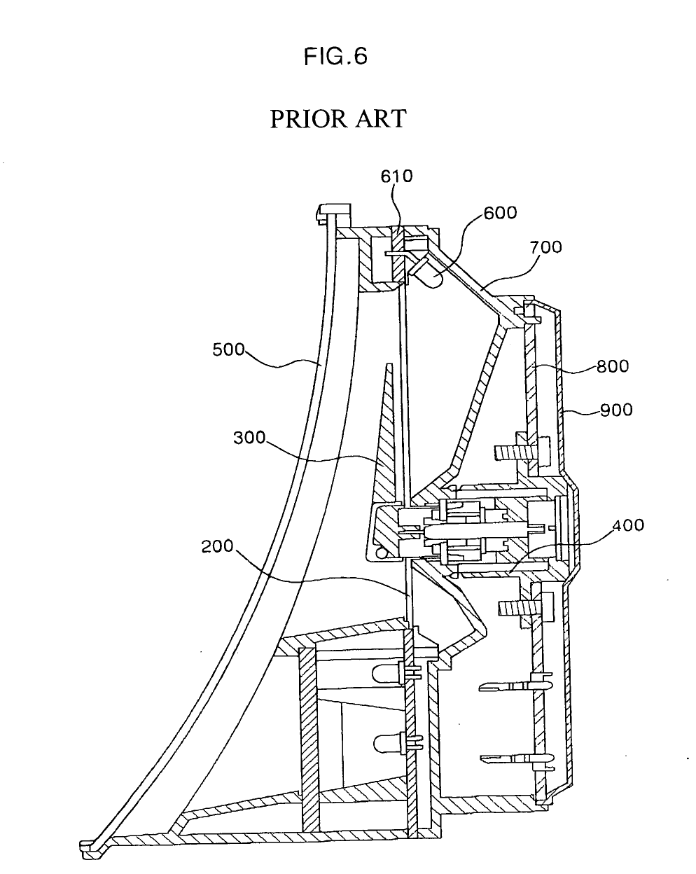

### DESCRIPTION OF THE PREFERRED EMBODIMENT

Described below in detail is an instrument panel according to a preferred embodiment of the present invention with reference to the accompanying drawings.

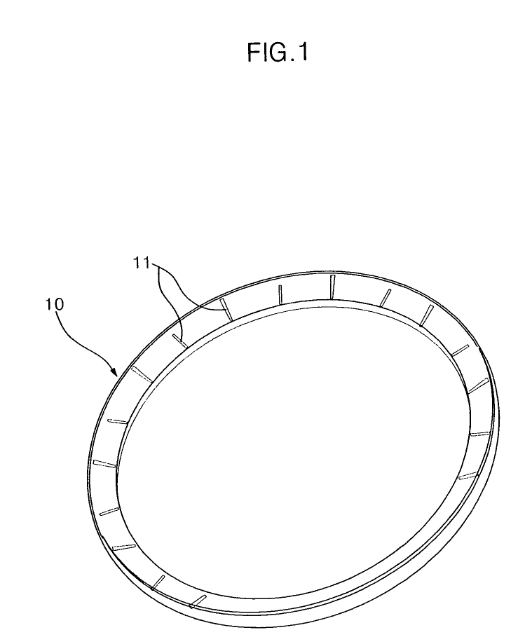

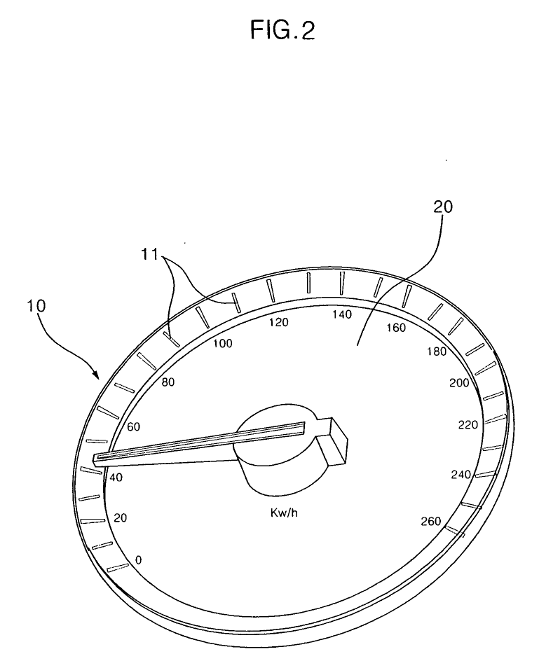

FIG. 1 is a perspective view of a three-dimensional illumination panel according to the present invention, and FIG. 2 is a perspective view showing the main part of an instrument panel for a vehicle installed with a three-dimensional illumination panel of FIG. 1.

As shown in these drawings, an instrument panel of the present invention has a display panel 20 with markings of various gauges, such as a speedometer, tachometer, hydraulic gauge, etc., printed thereon. On the display panel 20 is placed a three-dimensional illumination panel 10 which is three-dimensionally injection-molded so as to have a predetermined volume by using transparent material. The three-dimensional illumination panel 10 has a circular ring shape and is placed on the edge of the display panel 20.

In the inside of the three-dimensionally formed three-dimensional illumination panel 10, desired three-dimensional carvings, namely, markings or characters, are formed using Nd-YAG laser.

Especially the three-dimensional illumination panel 10, which is a work item of the present invention, is injection-molded with glass of transparent crystal or acryl (PMMA) resin, etc. so as to be able to identify, with the naked eye, the markings 11 or characters that are three-dimensionally formed in the three-dimensional illumination panel.

And the Nd-YAG laser, which is a means of carving the markings or characters three-dimensionally in the three-dimensional illumination panel, is solid laser, which is also known as gem laser. This laser uses crystals such as yttrium, aluminum and garnet as material for generating laser beam.

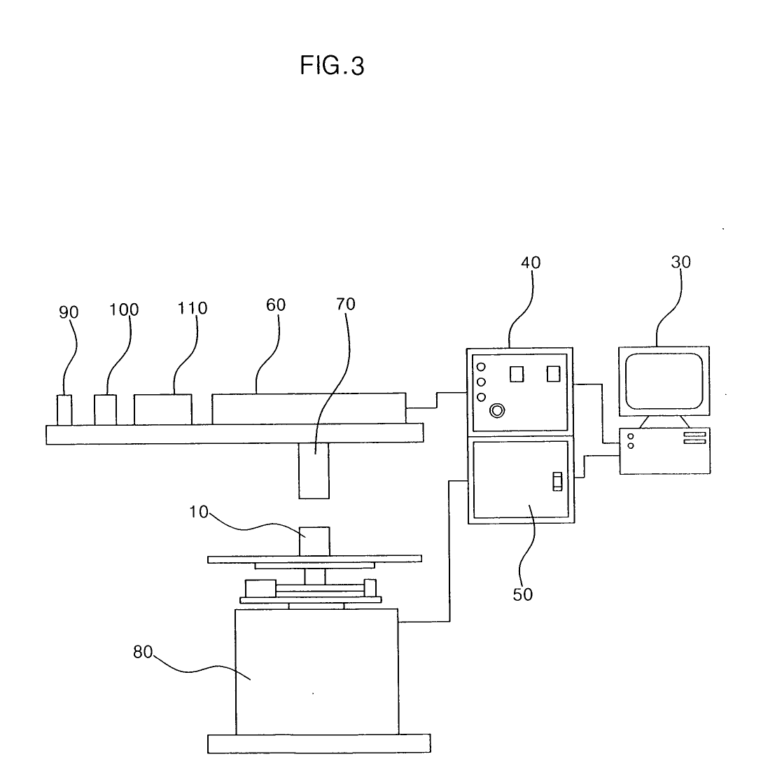

FIG. 3 is a schematic view showing a three-dimensional carver of a three-dimensional illumination panel according to the present invention.

As shown in FIG. 3, through the carving process using a three-dimensional carver, markings 11 or characters are formed in three-dimensional shapes on the three-dimensional illumination panel having a predetermined volume. In general, the three-dimensional carver includes a laser reflector 90, a magnifying lens 100, a lamp 110, a laser power supply 40 for controlling laser, an Nd-YAG laser device 60 for converting the wavelength of the irradiated laser from 1064 nm to 532 nm, and a computer 30 with a laser carving program built in. The computer 30 is connected to the laser power supply 40 and a motor power supply 50 which is under the laser power supply 40. The three-dimensional illumination panel to be processed is placed on a worktable 80, and laser from the Nd-YAG laser device 60 is irradiated on the three-dimensional illumination panel through focal lens 70.

The method of processing by a three-dimensional carver will be described briefly: When the Nd-YAG laser device 60 is operated to emit Nd-YAG laser and generate laser waves, laser processing goes on, as the Nd-YAG laser is magnified while passing through the magnifying lens 100 and is concentrated on the three-dimensional illumination panel 10 placed on the worktable 80 through the laser reflector 90 and focal lens 70.

At this time, as part of the three-dimensional illumination panel 10, where laser is concentrated, is being processed, it is carved into a three-dimensional shape according to the markings and characters inputted in the computer 30. Namely, when the computer 30 sends control signal to the motor power supply 50 in response to the shape of marking or character inputted in its storage device, the motor power supply 50 moves the worktable 80 in the directions of X, Y and Z axes so that a given marking or character is carved in a three-dimensional shape on the three-dimensional illumination panel 10.

Thus, since the display panel 20 according to the present invention is provided with a three-dimensional illumination panel 10 in which markings 11 or characters are carved three-dimensionally by laser processing, the visibility of the instrument panel is improved for the driver and the appearance becomes splendid.

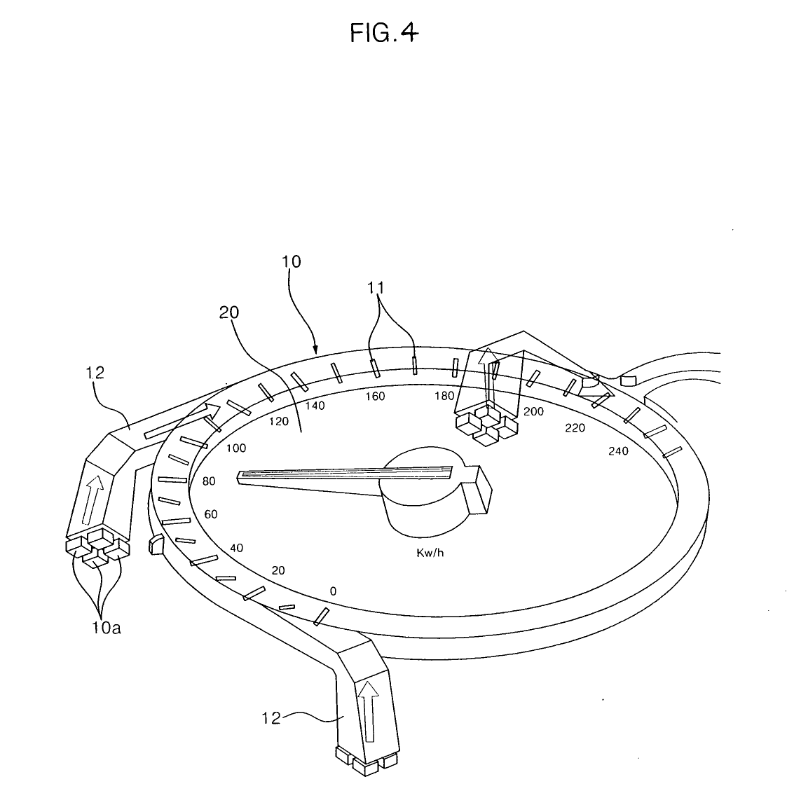

FIG. 4 is a perspective view showing an illumination structure of a colored LED installed on the instrument cluster for a vehicle according to the preferred embodiment of the present invention.

As shown in FIG. 4, in order to enhance the illumination effect by irradiating the three-dimensional illumination panel 10 with light of more diverse colors, the rear of the display panel 20 may be provided with a plurality of colored LED 10a that emit light in diverse colors (for example, white, blue, red, green or yellowish brown).

Also, the instrument panel of the present invention is provided with an illumination guidance tube 12 which reflects the light of colored LED to guide it onto the three-dimensional illumination panel 10 so that the light of colored LED 19a can illuminate the three-dimensional panel 10 from the side. One end of the illumination guidance tube 12 is placed in the vicinity of colored LED 10a and the other end is oriented to one side of the three-dimensional illumination panel 10.

If the three-dimensional illumination panel 10 is illuminated using such a colored LED 10a, the light of colored LED 10a is diffusely reflected on three-dimensional markings 11 or characters which are processed by Nd-YAG laser. Therefore, the driver can see the markings or characters on the three-dimensional illumination panel 10 in three-dimensional shapes by means of the diffusely reflected light.

Accordingly, the driver gets an optical illusion as if markings 11 or characters were suspended above the instrument panel so that the markings or characters of the instrument panel are highlighted and the visibility of the instrument panel is improved.

Furthermore, since the markings 11 or characters are illuminated by colored LED 10a of diverse colors, it not only gives a feeling as if the markings or characters were suspended in space, but also the vehicle can be made to look more classy with splendid appearance.

Meanwhile, it is possible to further enhance the classy feeling of the instrument panel by three-dimensionally forming patterns or pictures other than markings or characters.

As described above in detail, the present invention is provided with a three-dimensional illumination panel formed with transparent material so as to have a predetermined volume on the display panel making up the instrument cluster for a vehicle, and in the three-dimensional panel, the markings or characters are formed in three-dimensional solids by Nd-YAG laser, and these are illuminated by colored LED having diverse colors, so that specific parts of the instrument panel are highlighted so as to improve the visibility of the instrument panel for the driver.

Moreover, since it is possible to easily carve various patterns or pictures as well as three-dimensional markings or characters on the three-dimensional illumination panel by simple carving work of laser, the instrument panel can be designed freely according to the taste of the driver.

In addition, the vehicle can be made to look more classy with expression of various colors using colored LED as well as three-dimensional illumination for nighttime illumination of the instrument panel.

Although the present invention has been described in detail reference to its presently preferred embodiment, it will be understood by those skilled in the art that various modifications and equivalents can be made without departing from the spirit and scope of the present invention, as set forth in the appended claims.

1. An instrument cluster for a vehicle, comprising:
a display panel with markings and characters of various gauges, such as a speedometer, tachometer and hydraulic gauge, displaying information on various conditions and operations of vehicle;
an indicating pointer for indicating the markings;
an LED placed at a rear side of the display panel for illuminating the display panel during nighttime operation;
a gauge motor for rotating the indicating pointer; and
a three-dimensional illumination panel which is placed on the display panel and has markings or characters formed three-dimensionally by Nd-YAG laser.

2. The instrument cluster for a vehicle according to claim 1, further comprising a plurality of colored LEDs placed at the rear side of the display panel so as to illuminate the three-dimensional illumination panel in diverse colors.

3. The instrument cluster for a vehicle according to claim 2, wherein diverse patterns and pictures are formed in three-dimensional shapes inside of the three-dimensional illumination panel by Nd-YAG laser.

4. The instrument cluster for a vehicle according to claim 1, wherein the three-dimensional panel is injection-molded with acryl resin, which is a transparent material.

5. The instrument cluster for a vehicle according to claim 1, wherein the three-dimensional illumination panel is made of crystal material.
